(19) United States
(12) Patent Application Publication
(10) Pub. No.: US 2024/0165646 A1
(43) Pub. Date: May 23, 2024

(54) ATOMIZER ASSEMBLY AND SYSTEM

(71) Applicant: Jain Irrigation Systems Limited, Jalgaon (IN)

(72) Inventors: Ajit Bhavarlal JAIN, Jalgaon (IN); Aditya JOSHI, Jalgaon (IN)

(21) Appl. No.: 18/281,793

(22) PCT Filed: Apr. 8, 2022
(86) PCT No.: PCT/IN2022/050341

§ 371 Date: Sep. 13, 2023

(30) Foreign Application Priority Data
Apr. 8, 2021 (IN) 202121016512

(51) Int. Cl. B05B 12/14; B05B 1/16; B05B 7/04; B05B 7/10; B05B 7/24

(52) U.S. Cl. CPC B05B 12/1418; B05B 1/16; B05B 7/0416; B05B 7/2486; B05B 7/10

(57) ABSTRACT

An atomizer for flexible operation and a system with the same include a body including a plurality of independent inlets, where the body has a central axis “X”, a plurality of independent tubes coaxially integral with the body and connected to the plurality of inlets, where at least one tube is mounted along the central axis, at least one nozzle mounted concentrically to the at least one tube mounted along the central axis, at least one nozzle cap coupled concentrically to the body mounted along the central axis. The atomizer is configured to operate in at least one of a pneumatic mode and a hydraulic mode, when the at least one nozzle receives at least one input fluid from at least one inlet from the plurality of inlets.

### CROSS-REFERENCE TO RELATED APPLICATIONS

This application is the National Stage of International Application No. PCT/IN2022/050341, filed Apr. 8, 2022, which claims the benefit of India Application No. 202121016512, filed Apr. 8, 2021, the contents of which is incorporated by reference herein.

### TECHNICAL FIELD

The present disclosure relates to liquid atomizers and more particularly to an atomizer assembly and systems having a pneumatic atomizer that can be converted into a hydraulic atomizer.

### BACKGROUND

Atomizer is commonly used for spraying fine droplets. The droplets ejected out produces high ratio of surface to mass in the liquid and thereby achieving high rates of mixing and evaporation. The atomizer may be used in achieving cooling and humidity in the greenhouse, spraying agricultural chemicals to crops, paint spraying, spray drying, gas-liquid mass transfer application and many other applications. The atomizers are classified into two macro categories. A hydraulic atomizer is a first category, spraying the liquid with the only hydraulic pressure. The hydraulic atomizer works on pressure swirl mechanism and the fluid under pressure passes through a plurality of vanes tangentially connected to a vortex chamber. An outlet orifice is generally concentric and in fluid communication with the vortex chamber for dispersing a liquid spray. Usually, the pressure of the fluid in the hydraulic atomizers varies from medium to high, and the high pressure fluid generates drops with smaller diameter.

Another category of atomizer is a pneumatic atomizer. In the pneumatic atomizer, the compressed air (or other gases) mixes with the liquid from pulverize, producing a very fine spray nebulisation. In the pneumatic atomizers, the pressures of the fluids involved are usually relatively low and almost not more than 3 bar. The pneumatic atomizer is classified into an internal mix pneumatic atomizer and an external mix atomizer. In the internal mix type, the liquid is mixed inside the nozzle to produce an atomised spray. In case of external mix type, the air mixing with the liquid is obtained outside the nozzle.

Both the types of atomizers, hydraulic and pneumatic atomizers are designed separately, however, it is not possible to use the pneumatic atomizer as only the hydraulic atomizer and vice-a-versa. If the hydraulic atomizer is to be upgraded to the pneumatic atomizer, a separate product of pneumatic atomizer can be used and replace the hydraulic atomizer. If a pneumatic atomizer is already being used and in case of failure of pneumatic supply, the atomizer cannot work only with hydraulic supply.

Hence, there is a need for a single atomizer assembly and system configured to work as a hydraulic atomizer and a pneumatic atomizer.

### OBJECT OF THE INVENTION

It is the primary object of the present disclosure to provide an atomizer assembly configured to work as a hydraulic atomizer for a single fluid input.

It is another object of the present disclosure to provide an atomizer assembly configured to work as a hydraulic atomizer and a pneumatic atomizer for a dual fluid input.

It is still another object of the present disclosure to provide a system with an atomizer assembly for a primary atomisation process with/without a secondary atomisation process.

It is still another object of the present disclosure to provide a method for atomising fluids using a pneumatic atomizer.

It is still another object of the present disclosure to provide a method of generating fine droplets at low pneumatic and hydraulic pressure as compared to conventional atomizers.

### SUMMARY

In one aspect of the present disclosure, an atomizer for flexible operation is disclosed. The atomizer comprises a body comprising a plurality of independent inlets, wherein the body has a central axis “X”, a plurality of independent tubes coaxially integral with the body and connected to the plurality of inlets, wherein at least one tube is mounted along the central axis, at least one nozzle having a rear end and a front end, mounted concentrically to the at least one tube mounted along the central axis, at least one nozzle cap coupled concentrically to the body and the at least one nozzle mounted along the central axis enclosing the plurality of independent tubes and the at least one nozzle. The atomizer is configured to operate in at least one of a pneumatic mode and a hydraulic mode, when the at least one nozzle receives at least one input fluid from at least one inlet from the plurality of inlets.

In another aspect of the present disclosure, a system for flexible automizing comprising a plurality of fluid supply units and at least one atomizer is configured to connect with the plurality of fluid supply units is disclosed. The atomizer comprises a body comprising a plurality of independent inlets, wherein the body has a central axis “X”, a plurality of independent tubes coaxially integral with the body and connected to the plurality of inlets, wherein at least one tube is mounted along the central axis, at least one nozzle having a rear end and a front end, mounted concentrically to the at least one tube mounted along the central axis, at least one nozzle cap coupled concentrically to the body and the at least one nozzle mounted along the central axis enclosing the plurality of independent tubes and the at least one nozzle. The atomizer is configured to operate in at least one of a pneumatic mode and a hydraulic mode, when the atomizer receives at least one input fluid from at least one fluid supply unit from the plurality of supply units. The at least one nozzle is configured to receive at least one input fluid from at least one inlet from the plurality of inlets.

In yet another aspect of the present disclosure, an atomizer assembly configured to work for a single fluid input and a dual fluid input is disclosed. The atomizer assembly is a pneumatic atomizer having an internal mixing arrangement. The same pneumatic atomizer can be converted to a hydraulic atomizer. The atomizer assembly provides a flexibility to utilise same atomizer as a hydraulic atomizer as well as a pneumatic atomizer. In case, a pneumatic supply is not available or there is a break down in pneumatic supply, the same atomizer can be used as the hydraulic atomizer and later when pneumatic supply is available, the same atomizer can be used as the pneumatic atomizer.

### BRIEF DESCRIPTION OF THE DRAWINGS

For better understanding, the invention will now be described, in a non-limiting example only, by way of example only, with reference to the accompanying figures.

FIG. 1A illustrates an isometric view of an atomizer in accordance with an exemplary embodiment of the present invention.

FIG. 1B illustrates a longitudinal sectional view of the atomizer in accordance with the present invention.

FIG. 2A illustrates an isometric view of the Nozzle cap in accordance with the present invention.

FIG. 2B illustrates a longitudinal cross-sectional view of the nozzle cap in accordance with the present invention.

FIG. 3A illustrates isometric view of the nozzle cap and the nozzle in accordance with an exemplary embodiment of the present invention.

FIG. 3B illustrates top view of the nozzle cap and the nozzle in accordance with an exemplary embodiment of the present invention.

FIG. 4 illustrates an exploded isometric view of the atomizer in accordance with the present invention.

FIG. 5A illustrates a longitudinal sectional view of the nozzle, showing the nozzle orifice diameter in accordance with the present invention.

FIG. 5B illustrates an isometric view of nozzle showing ribbed inlet for swirling action in accordance with the present invention.

FIG. 6 illustrates a longitudinal sectional view of the atomizer with leakage prevention device in accordance with the present invention.

FIG. 7 illustrates longitudinal sectional view of the atomizer with intended use as a hydraulic atomizer having air inlet plugged.

FIG. 8A illustrates a sectional view of the atomizer having two nozzles in accordance with another embodiment of present invention.

FIG. 8B illustrates an isometric view of the atomizer having two nozzles in accordance with another embodiment of present invention.

FIG. 9A illustrates a sectional view of the atomizer having four nozzles in accordance with yet another embodiment of present invention.

FIG. 9B illustrates an isometric view the atomizer having four nozzles in accordance with yet another embodiment of present invention.

### DETAILED DESCRIPTION OF THE INVENTION

The term “atomizer” as used herein in the specification and claims refers collectively to a device capable of emitting a fine mist of liquid. Such devices are often referred to in the art also as foggers, sprayers, mist devices, humidifiers, etc.

In the present invention, an automiser assembly and a system having the same are disclosed. The present invention relates to generation of fog using the atomizer assembly. The atomizer is advantageous to be used with a single fluid as a hydraulic atomizer and with dual fluid as a pneumatic atomizer. Commonly, single fluid means water and dual fluid means water and air. Thus, the present invention gives a flexibility to operate the atomizer as a hydraulic atomizer and as a pneumatic atomizer based on droplet size requirement. The pneumatic atomizer of the present invention starts working as hydraulic atomizer just by plugging the pneumatic supply. When medium to large size droplets are required, the atomizer assembly can be used as a hydraulic atomizer and when finer droplets are required the same atomizer can be used as pneumatic atomizer.

Further, the present invention also gives flexibility to invest the atomizer assembly as a hydraulic atomizer initially and at a later stage, the same atomizer can be converted to a pneumatic atomizer. The present invention also offers operational safety to a user, in case the air supply to the atomizer assembly is stopped due to a maintenance requirement during operation, the atomizer assembly switches over from the pneumatic atomizer to hydraulic atomizer, and prevents crop damage due to direct jetting.

In an embodiment of the present disclosure, an atomizer for a flexible operation is disclosed. The atomizer comprises a body comprising a plurality of independent inlets, wherein the body has a central axis “X”, a plurality of independent tubes coaxially integral with the body (103) and connected or in communication with the plurality of inlets, wherein at least one tube is mounted along the central axis, at least one nozzle having a rear end and a front end, mounted concentrically to the at least one tube mounted along the central axis, at least one nozzle cap coupled concentrically to the body and the at least one nozzle mounted along the central axis enclosing the plurality of independent tubes and the at least one nozzle. The at least one nozzle receives at least one input fluid through at least one tube from the plurality of tubes.

The atomizer is configured to operate in at least one of a pneumatic mode and a hydraulic mode, when the at least one nozzle receives at least one input fluid from at least one inlet from the plurality of inlets. The plurality of inlets configured to receive air and liquid as inputs. The atomizer is configured to operate in the pneumatic mode when the nozzle receives gas and the liquid from the plurality of independent inlets. The atomizer is configured to operate in the hydraulic mode when the nozzle receives liquid from at least one inlet of the plurality of inlets.

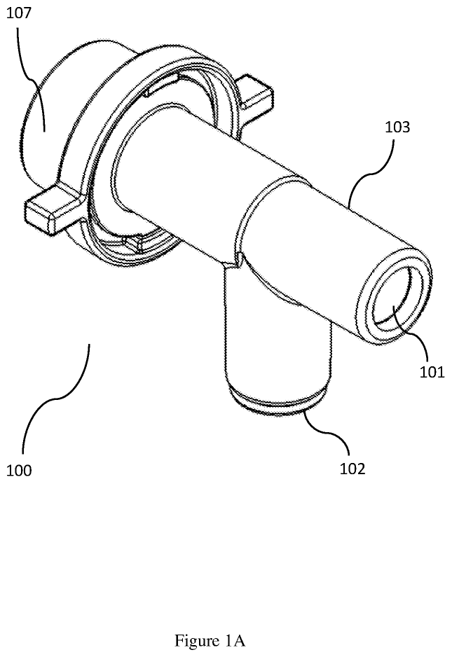

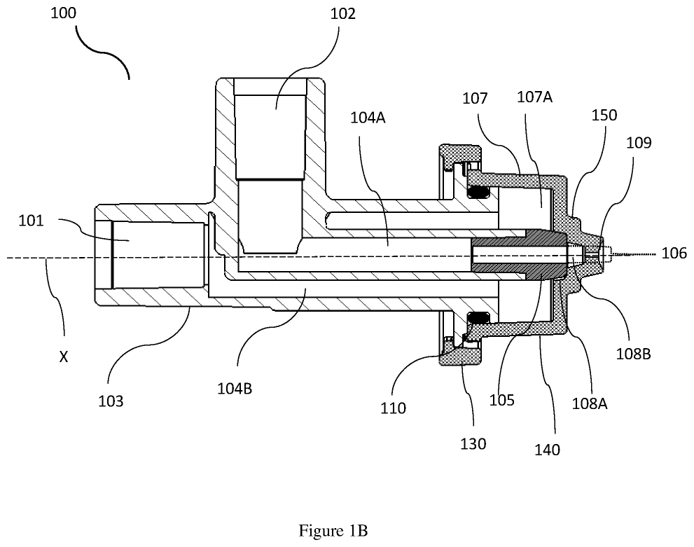

Referring to FIG. 1, illustrated is an atomizer in accordance with an exemplary embodiment of the present disclosure. FIG. 1A illustrates an isometric view of an atomizer, whereas FIG. 1B illustrates a longitudinal sectional view of the atomizer in accordance with the present invention. The Atomizer (100) comprises at least four major components responsible for functioning, which comprises a body (103) having central axis “X” as shown in FIG. 1B, a nozzle (105), circular tubes (104A, 104B), a nozzle cap (107) and a sealing ring (110) as shown in FIGS. 1A and 1B. Since air is widely used for the gaseous flow, the gaseous flow is described as ‘air’ here. As shown in FIG. 1B, the body (103) comprises two inlets (101, 102) integrally formed for the flow of air and liquid. The Atomizer (100) comprises a circular tube (104A) and a circular tube (104B) arranged coaxially towards the nozzle (105) and integral with the body (103). The circular tube (104A) and a circular tube (104B) are independent with each other. The circular tube (104A) is concentrically aligned along the central axis “X” and surrounded by the circular tube (104B). The tube (104A) carries air through a channel within the tube (104A) towards the nozzle (105). The tube (104A), the nozzle (105) and the nozzle cap (107) are concentrically mounted along the central axis. In an example of the present invention, The tube (104A), the nozzle (105) and the nozzle cap (107) are integrally mounted within the body or integral part of the body (103).

The tube (104B) is configured to carry liquid through an annular space formed between the tube (104A) and the tube (104B). The liquid, such as water, enters the atomizer through a liquid inlet (101) and air enters the atomizer through an air inlet (102). In another exemplary embodiment of the present disclosure, the tubes (104A) and (104B) are configured to use as separate and independent tubes and not arranged coaxially towards the nozzle (105). In yet another exemplary embodiment of the present invention, the inlets and the tubes may be configured to have a constant diameter for the flow of fluids In yet another exemplary embodiment of the present invention, the inlets and the tubes may be configured to have a variable diameter for the flow of fluids. The variable diameter of the inlets and tubes may be configured with converging walls from a one end towards another end of the inlets or tubes, as the case may be.

The nozzle (105) has a rear end and a front end mounted concentrically to the at least one tube mounted along the central axis. The nozzle (105) is configured to concentrically mate to the tube (104A). The nozzle has an orifice (106) having a predefined diameter configured to mate with the tube (104A). Further, the nozzle cap (107) is configured mate to the atomizer body (103). In one embodiment, The orifice (106) may be concentrically aligned and configured to have a constant diameter. In another embodiment, the orifice (106) may be concentrically aligned and configured to have a variable diameter, where the walls of the orifice (106) may converge towards the front end of the nozzle (105) or towards the rear end of the nozzle (105). Sealing of the parts, such as nozzle cap and nozzle, is achieved by using a sealing ring (110) as shown in FIG. 1B. The nozzle (105) receives gas from the tube (104A) from a gas supply unit.

As shown in FIG. 1B, the nozzle cap (107) comprises three major portions or sections: a base portion (130), a middle portion (140), and a discharge portion (150). The nozzle cap (107) is also configured to mate concentrically to the nozzle (105) and body (103) enclosing independent tubes and the nozzle (105). The base portion (130) has a plurality of handles and a receptacle (135) with a coupling means adapted to couple with the body (103). The coupling means may comprise one of a press fitting arrangement, a fastening arrangement, an adhesive, a threaded connection, and a snap-fit arrangement. Further, the middle portion (140) comprises a fluid holding bath (107A) adjacent to the receptacle. The fluid holding bath (107A) is configured to receive liquid from tube (104B) from the liquid inlet (101) from a liquid supply unit. Further, the discharge portion (150) may comprise a cavity (108) adjacent to the fluid holding bath (107A) configured to couple with the nozzle (105) and maintained in a tight position and an outlet orifice (109) adjacent to the discharge portion concentrically aligned to discharge or spray output fluid or mixture of fluid as droplets.

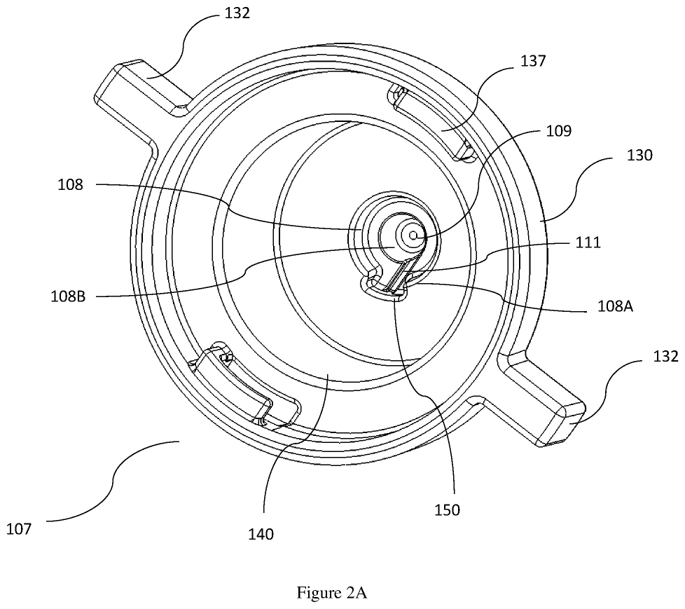

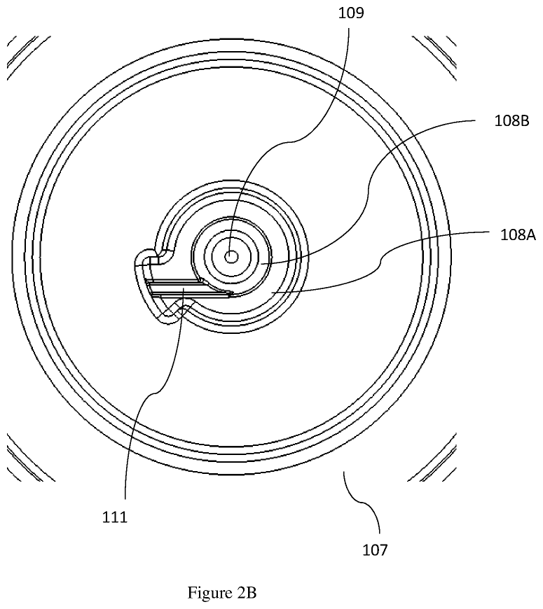

Referring to FIGS. 2A-2B, illustrate an isometric view and a longitudinal cross-sectional view of the nozzle cap (107) respectively, in accordance with the present disclosure. The geometry of the nozzle cap (107) is disclosed in FIGS. 2A and 2B. FIG. 2B illustrates a close top view of the nozzle cap (107). The cavity (108) comprises a first chamber (108A) having a fluid entering means and a second chamber, also called as a ‘vortex chamber’ (108B) placed centrally at the nozzle cap (107). Side walls of the vortex chamber (108B) converge towards outlet orifice (109). The first chamber is configured to mate with the front end of the nozzle (105) leaving a small portion of the fluid entering means open or entering to the second chamber for the flow of input fluid. The fluid entering means comprises a plurality of tangential vane slots (111) enabling the liquid to enter tangentially into the vortex chamber (108B). The nozzle cap (107) is configured to mate concentrically to the nozzle (105) to seal the vortex chamber (108B). The side walls of the first chamber (108A) and the second chamber (108B) converge towards the outlet orifice (109). The first chamber is configured to have a greater diameter than the diameter of the second chamber.

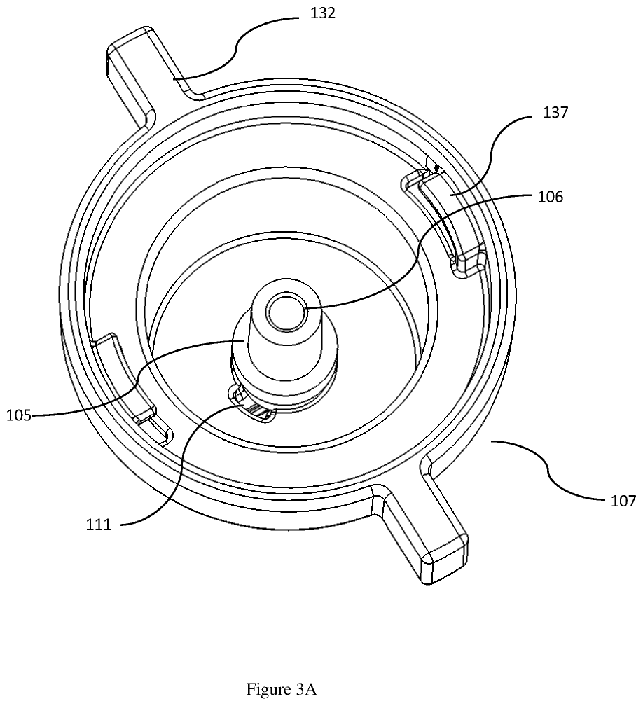

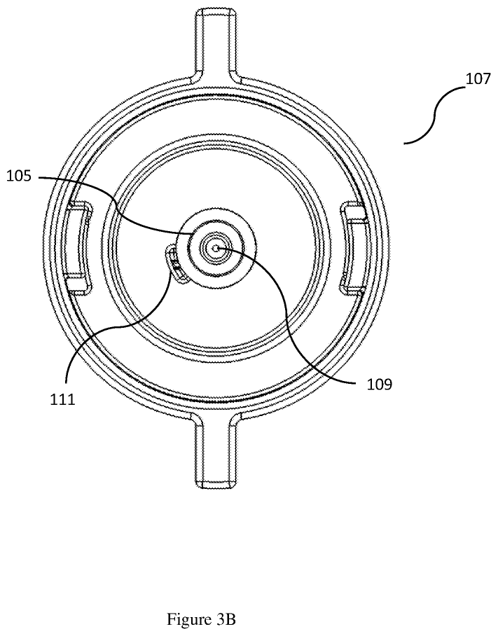

FIG. 3A-3B, illustrate an isometric view and a top view of the nozzle cap (107) mating with the nozzle (105) in accordance with the present invention. FIG. 3B illustrates a top view of the nozzle cap (107) mating with the air nozzle (105). The nozzle (105) is placed concentrically on the chambers (108A, 108B) of the cap leaving a small portion of the tangential vane slots (111) open. Liquid enters tangentially into the vortex chamber (108B) through the plurality of vane slots (111).

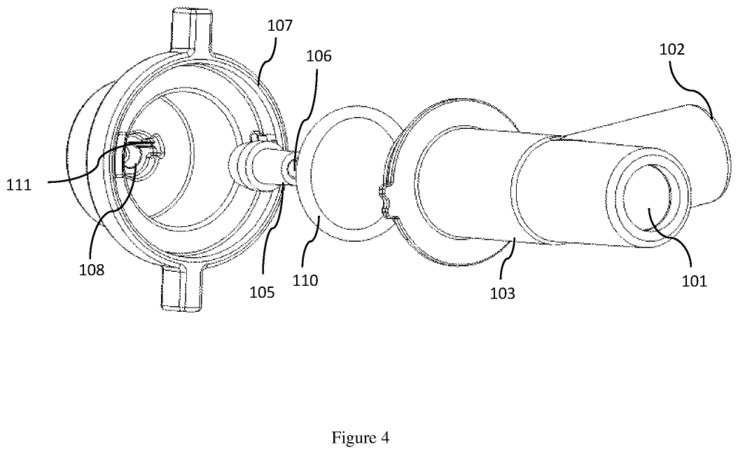

FIG. 4 illustrates an exploded isometric view of the atomizer assembly in accordance with the present invention. The body (103) and the nozzle cap (107) are coupled through a sealing means, wherein the sealing means is adapted to maintain a tight position between the body (103) and the nozzle cap. In one embodiment, the sealing means comprises a sealing ring (110), not only limited to, but any suitable arrangement may also be selected for the sealing means to maintain a tight position between the body (103) and the nozzle cap.

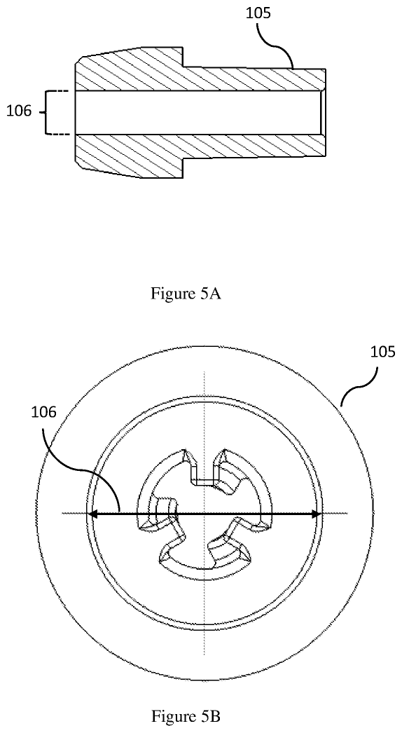

FIG. 5A illustrates a longitudinal sectional view of the nozzle (105) in accordance with the present invention. The inner diameter of the air nozzle (105) may be straight or a variable diameter with convergence towards the discharge orifice (106). In another exemplary embodiment disclosed in FIG. 5B, the inner section of the nozzle (105) may have a plurality of swirl fins (114) causing the fluid to swirl, in this case “air”. The swirling direction of fins may be in a clockwise or anticlockwise direction. Fluid may enter the nozzle at one end, the plurality of swirl fins (114) may spin due to the fluid flowing through the nozzle and discharge the fluid with swirl motion at the other end of the nozzle. The swirl direction is either in the same direction as the vane slots (111) or in a direction opposite to vane slots (111).

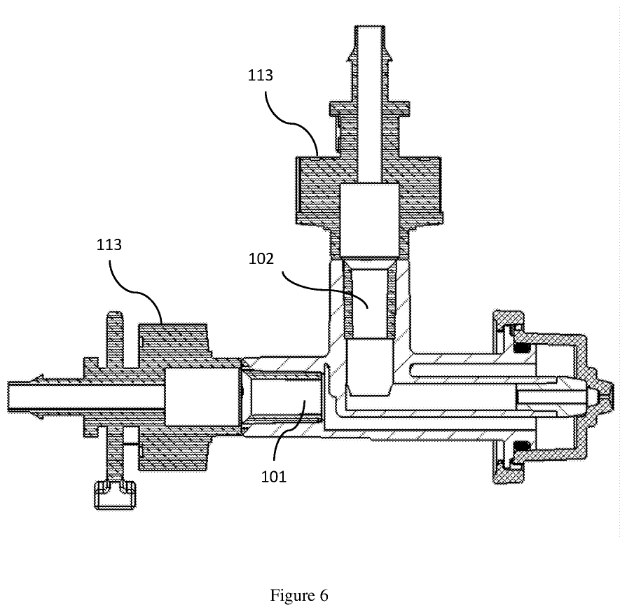

FIG. 6 illustrates a longitudinal sectional view of the atomizer with a leakage prevention device (LPD) in accordance with the present invention. The leakage prevention device (113) is a standard component allowing fluid to flow through it when a predesigned opening pressure arrives. The leakage prevention device (113) may be configured to fit on either or both the liquid inlet (101) or/and the air inlet (102). The opening pressure for the leakage prevention device (113) used on the air inlet (102) and the liquid inlet (101) may be equal or different. In an exemplary example of the present invention as shown in FIG. 6, the leakage prevention device (113) is used at both the air inlet (102) and the liquid inlet (101) of the atomizer. The leakage prevention device is configured to open up at a predesigned pressure. The leakage prevention device (113) is used to prevent low head drainage of liquid or air through the supply line. The leakage prevention device also prevents reversal of the flow.

In one implementation of the present invention, a non return valve is used as an auxiliary device in place of the leakage prevention device. In another implementation of the present invention, a solenoid valve is used in place of the leakage prevention device. The solenoid valve may be used at both the liquid inlet (101) and air inlet (102). In another implementation of the present invention, at least one of the leakage prevention device, a check valve, the solenoid valve, or a combination thereof is used at the liquid inlet (101) and air inlet (102).

In an exemplary example, the leakage prevention device (LPD) is fitted at the liquid inlet (101) and the non-return valve is fitted at the air inlet (102). In another exemplary example, the leakage prevention device (LPD) is fitted at the liquid inlet (101) and the electrically operated valve is fitted at the air inlet (102). The atomizer may function as pneumatic atomizer even if at least one of leakage prevention device, a check valve, a solenoid valve is not used in a watering system.

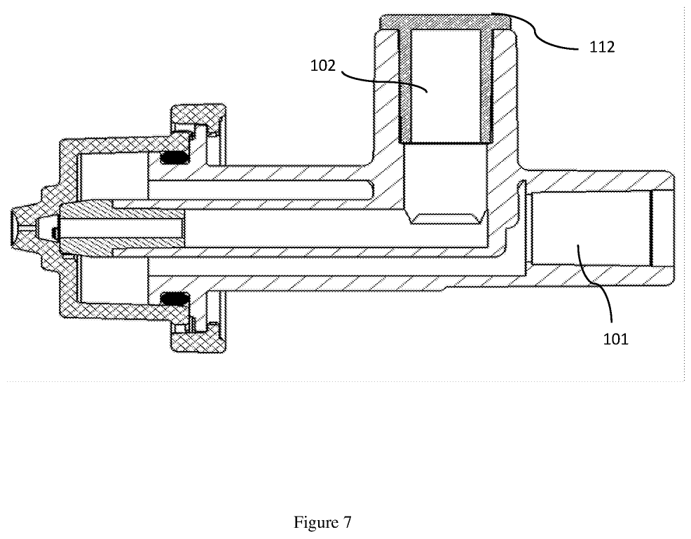

FIG. 7 illustrates longitudinal sectional view of the atomizer functioning as a hydraulic atomizer in accordance with the present invention. FIG. 7 shows the possibility of atomizer assembly functioning only as hydraulic atomizer by closing or sealing the air inlet (102) using a plug (112) or a closure unit.

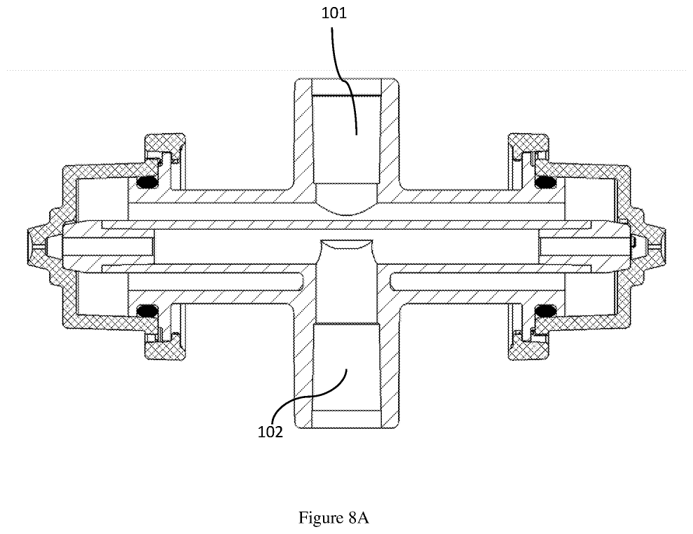

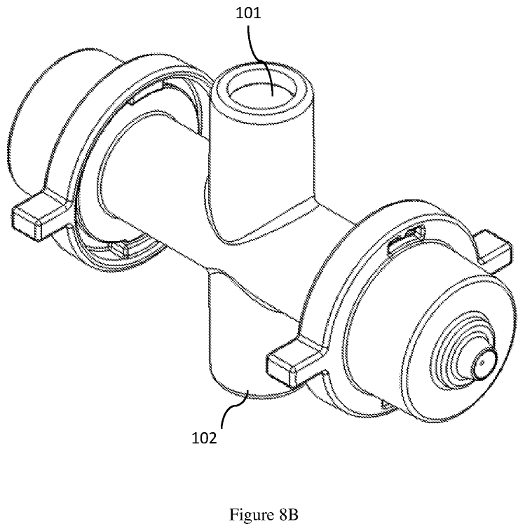

FIG. 8A shows a sectional view of an atomizer having two nozzles in accordance with another embodiment of present invention. The atomizer has a single air inlet (102), single liquid inlet (101) with two atomizer nozzles. FIG. 8B shows an isometric view of the atomizer nozzles described in FIG. 8A.

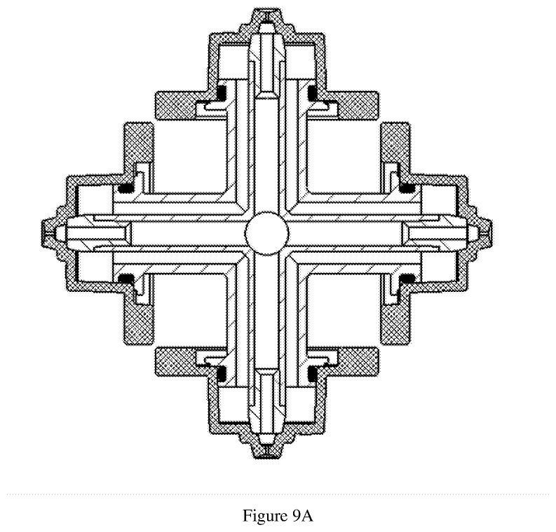

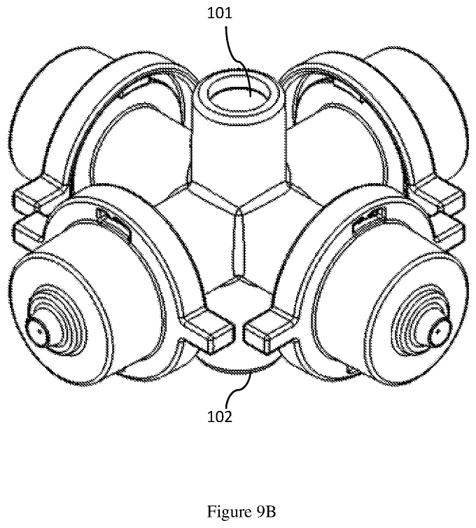

FIG. 9A a top sectional view of an atomizer having four nozzles in accordance with yet another embodiment of present invention. The atomizer has a single air inlet (102), single liquid inlet (101) with four atomizer nozzles. FIG. 9B shows an isometric view of the atomizer nozzle described in FIG. 9A.

The working of the atomizer undergoes two fold process: a first part process is a primary atomisation involving a hydraulic atomisation, another part of the process is a secondary atomisation involving a pneumatic atomisation. The hydraulic atomisation process is explained as below.

Liquid under pressure enters into the atomizer (100) through the liquid input (101) of the body (103) of the atomizer and travels through the annular space. Liquid then enters into the liquid holding chamber (107A) of the atomizer nozzle cap (107). Further, liquid enters into the first chamber (108A) and the vortex chamber (108B) through the plurality of vane slots (111) organised tangentially to one end of vortex chamber (108B). One end of the vortex chamber (108B) is sealed with one end of nozzle (105). One end of the nozzle (105) also covers the vane slot leaving a small opening to allow entry of liquid through plurality of vane slots (111). The liquid flowing through the plurality of vane slots generates a swirling action and generates spiral vortex flow and further flows towards the other end of the vortex chamber (108B). The vortex chamber (108B) has a converging shape from one end to the other end and the diameter of the first end is equal or greater than the diameter of the other end of the vortex chamber (108B).

An outlet orifice (109) is coaxial to the vortex chamber (108B) and the first chamber (108A). when entering into the liquid input (101), Liquid has a predefined pressure energy, the pressure energy of the liquid is converted into bulk kinetic energy while the liquid is entering through the plurality of vane slots (111), as vane slots (111) are tangential to vortex chamber (108B), liquid swirls inside the chamber and the angular velocity of the liquid increases and get the liquid pushed towards the outer wall of the vortex chamber causing a thin swirling film of liquid, resulting to shearing due to which the liquid gets atomised and ejected out through the outlet orifice (109) in a form of a plurality of blobs of liquid. Size of the blobs of liquid ejected out during primary atomisation is usually larger with an average droplet size ranging between 60 to 200 microns at an average pressure of 3 to 4 kg/cm². The average droplet size decreases with increase in pressure of the liquid at the inlet, and hence in order to generate finer droplets using only primary atomisation or hydraulic atomisation requires higher pressure energy input.

Further, the secondary atomisation involving a pneumatic atomisation process is explained as below. In the secondary atomisation, blob of liquid formed in the primary atomisation phase undergoes further breakup. Air under pressure enters through the air inlet (102) and travels through the tube (104A). The nozzle may be parallel or converging from one end to another end. The other end of nozzle (105) is mating to the nozzle cap (107) in such a way that the nozzle cap seals the vortex chamber (108B) and vane slots (111). Then liquid from the tube (104B) approaches through the annular space to the vane slot (111). Liquid entered in the first chamber (108A) and vortex chamber (108B) forms a thin swirling film as explained in primary atomisation process. Further, air under pressure compresses the thin liquid film and causes additional shear on the inner part of the swirling liquid film. The additional shear causes further break up of liquid blobs into finer droplets. Further, due to kinetic energy of the compressed air, atomised finer droplets may be carried to farther distance. The droplet size and spread of the droplets may be varied by adjusting the gas to liquid ratio.

In another exemplary embodiment of the present invention, the nozzle may comprise a plurality of swirl vanes causing air swirling action while air is entering into the vortex chamber (108B). If the direction of the air swirl is opposite to that of liquid swirling, a heavy shearing occurs at the inner part of liquid swirl film. The heavy shearing may cause further break up of liquid droplet and droplet may spread in high frequency in vicinity rather than travelling farther. If the direction of air swirl is same as the liquid swirl, angular velocity of liquid swirl film may increase and give a fine breakup of the droplet and droplet may move to farther distance due to the kinetic energy of air.

In one exemplary embodiment of the present invention, the atomizer body having tubes, inlets is molded and made as a single piece. Similarly, the nozzle cap may be molded and made as a single piece. In another exemplary embodiment of the present invention, the atomizer assembly integral with the nozzle cap may be molded and made as a single piece. In yet another example of the invention, the atomizer (100) may be assembled from multiple pieces through various connecting means.

In yet another embodiment of the present disclosure, a system for flexible automizing comprising a plurality of fluid supply units and at least one atomizer (100) is configured to connect with the plurality of fluid supply units is disclosed. The atomizer comprises a body comprising a plurality of independent inlets, wherein the body has a central axis “X”, a plurality of independent tubes coaxially integral with the body and connected to the plurality of inlets, wherein at least one tube is mounted along the central axis, at least one nozzle having a rear end and a front end, mounted concentrically to the at least one tube mounted along the central axis, at least one nozzle cap coupled concentrically to the body and the at least one nozzle mounted along the central axis enclosing the plurality of independent tubes and the at least one nozzle. The atomizer is configured to operate in at least one of a pneumatic mode and a hydraulic mode, when the atomizer (100) receives at least one input fluid from at least one fluid supply unit from the plurality of supply units. The at least one nozzle (105) is configured to receive at least one input fluid from at least one inlet from the plurality of inlets.

The system further may comprise a closure unit (112) configured to seal at least one inlet of the atomizer (100). The system further may comprise at least one auxiliary device (113) coupled with at least one inlet from the plurality of inlets for preventing the leakage and reverse flow of the input fluid. The at least one auxiliary device comprises one of a leakage prevention device, a non-return valve, a check valve, a solenoid valve, and a combination thereof.

The present invention allows to use the atomizer assembly as a hydraulic atomizer only for the primary atomisation process. The present invention also allows use the same atomizer as a pneumatic atomizer for the secondary atomisation process along with primary atomisation. Such use is applicable but not limited to applications like cooling and humidification in greenhouse. In greenhouse, cooling is required when temperature is high and for crops. The atomizer may operate as only hydraulic atomizer initially to generate larger drops when the temperature is high and then the atomizer may operate for secondary atomisation process to generate smaller droplet sizes when the temperature is relatively low. Generated large drops may exchange heat and cool faster without wasting energy in compressed air supply. Further, when the temperature is relatively low, an evaporative cooling is not possible for larger droplets, secondary atomisation process is activated to generate smaller droplet sizes.

The present invention further provides a flexibility to use the atomizer initially as a hydraulic atomizer and then to convert the same into a pneumatic atomizer. For achieving the flexibility, a plug (112) is added to close the air inlet (102). With the closed air inlet, the atomizer acts as a hydraulic atomizer. The plug (112) is removed and the air supply is connected to the air inlet (102) to convert the same to pneumatic atomizer. In case the air supply is failed due to a maintenance in a compressor or due to any other reasons, the present invention provides flexibility to use the atomizer as a hydraulic atomizer for a period till the air supply is not resumed rather than stopping the entire atomizer of the system. At least one of the leak prevention device, the non-return valve, the electric valve connected with the inlets prevents liquid flow spill over through the air inlet. The present invention is advantageous in applications such as cooling and humidification in greenhouses, where complete stopping of atomisation may lead to crop damage.

The present invention is designed for easy interchangeability from pneumatic to hydraulic and vice a versa without changing any internal parts. Atomizer described in present invention is compact, easy to assemble, parts are easily changeable. Droplet size and spreading frequency in atomizer can be varied by changing air-liquid ratio. The varying droplets facilitates to manage the cooling or humidification requirement according to outside temperature and humidity conditions.

The present invention has a great application in protected cultivation or in greenhouses requiring cooling and humidification to create the desired climatic conditions. The present invention can also be used in spray drying applications, paint applications. In general, the present invention has application to all the places requiring fine spray and average size of the droplet is needed to be varied by changing air—liquid ratio. Another application of the present invention is in the field of mixing of two fluids.

Although the present invention and exemplary examples are described with air and liquid as fluid, the fluid is not only limited to air and liquid or water, but any other possible fluids for may also be used in the aspect of the present invention, where two or more fluids are mixed and used for atomisation.

1. An atomizer, comprising:
a body comprising a plurality of independent inlets, wherein the body has a central axis “X”;
a plurality of independent tubes coaxially integral with the body and connected to the plurality of inlets, wherein at least one tube is mounted along the central axis;
at least one nozzle having a rear end and a front end, mounted concentrically to the at least one tube mounted along the central axis;
at least one nozzle cap coupled concentrically to the body and the at least one nozzle mounted along the central axis enclosing the plurality of independent tubes and the at least one nozzle;
wherein the atomizer is configured to operate in at least one of a pneumatic mode and a hydraulic mode, when the at least one nozzle receives at least one input fluid from at least one inlet from the plurality of inlets.

2. The atomizer as claimed in claim 1, wherein the at least one nozzle receives at least one input fluid through at least one tube from the plurality of tubes.

3. The atomizer as claimed in claim 1, wherein a closure unit is configured to seal at least one inlet of the atomizer.

4. The atomizer as claimed in claim 1, wherein the plurality of inlets comprises:
at least one inlet from the plurality of inlets configured to receive a first fluid from a first fluid supply unit; and
at least one other inlet from the plurality of inlets configured to receive a second fluid from a second fluid supply unit.

5. The atomizer as claimed in claim 4, wherein the first fluid supply unit is a liquid supply unit, and a second fluid supply unit is a gas supply unit.

6. The atomizer as claimed in claim 1, wherein the plurality of tubes comprises:
at least one tube from the plurality of tubes configured to allow a flow of gas through the tube towards at least one nozzle; and
at least one other tube from the plurality of tubes configured to allow a flow of liquid through the tube towards at least one nozzle cap.

7. The atomizer as claimed in claim 1, wherein the atomizer is configured to operate in the pneumatic mode, when the nozzle receives gas and the liquid from the plurality of independent inlets.

8. The atomizer as claimed in claim 1, wherein the atomizer is configured to operate in the hydraulic mode, when the nozzle receives liquid from at least one inlet of the plurality of inlets.

9. The atomizer as claimed in claim 1, wherein the nozzle cap is detachably coupled to the body with a coupling means, wherein the nozzle cap comprises:
a base portion comprising a plurality of handles and a receptacle with the coupling means adapted to couple with the body;
a middle portion comprising a fluid holding bath adjacent to the receptacle, wherein the fluid holding bath is configured to receive an input fluid from at least one tube from the plurality of independent tubes; and
a discharge portion comprising a cavity adjacent to the fluid holding bath configured to couple with the nozzle in a tight position and an outlet orifice adjacent to the discharge portion concentrically aligned to discharge output fluid or mixture of fluid.

10. The atomizer as claimed in claim 9, wherein the cavity comprises a first chamber having a fluid entering means and a second chamber or vortex chamber, wherein the first chamber is configured to mate with the front end of the nozzle leaving a small portion of the fluid entering means open to the second chamber for the flow of input fluid.

11. The atomizer as claimed in claim 9, wherein the coupling means comprises one of a press fitting arrangement, a fastening arrangement, an adhesive, a threaded connection, and a snap-fit arrangement.

12. The atomizer as claimed in claim 1, wherein the body and the nozzle cap are coupled through a sealing means, wherein the sealing means is adapted to maintain a tight position between the body and the nozzle cap.

13. The atomizer as claimed in claim 12, wherein the sealing means is a sealing ring.

14. The atomizer as claimed in claim 10, wherein the fluid entering means comprises a plurality of tangential vane slots enabling input fluid to enter tangentially into the second chamber.

15. The atomizer as claimed in claim 9, wherein at least one nozzle cap is configured to mate concentrically with the at least one nozzle to seal the second chamber.

16. The atomizer as claimed in claim 10, wherein side walls of the first chamber and the second chamber converge towards the outlet orifice.

17. The atomizer as claimed in claim 9, wherein the diameter of the first chamber is greater than the diameter of the second chamber.

18. The atomizer as claimed in claim 1, wherein nozzle comprises an orifice concentrically aligned and configured to have a constant diameter.

19. The atomizer as claimed in claim 1, wherein nozzle comprises an orifice concentrically aligned and configured to have a variable diameter, wherein walls of the orifice converge towards the front end of the nozzle or towards the rear end of the nozzle.

20. The atomizer as claimed in claim 1, wherein the nozzle comprises a plurality of swirl fins configured to swirl the input fluid.

21. The atomizer as claimed in claim 20, wherein a direction of rotation of the plurality of swirl fins is selected from a clockwise direction and an anticlockwise direction.

22. The atomizer as claimed in claim 20, wherein the plurality of swirl fins is configured to rotate in the same direction or the opposite direction as the vane slots.

23. The atomizer as claimed in claim 1, wherein at least one auxiliary device is coupled with at least one inlet from the plurality of inlets for preventing the leakage and reverse flow of the input fluid.

24. The atomizer as claimed in claim 23, wherein at least one auxiliary device comprises one of a leakage prevention device, a non-return valve, a check valve, a solenoid valve, and a combination thereof.

25. The atomizer as claimed in claim 1, wherein when the automizer is configured to operate in the pneumatic mode, a droplet size and a spreading frequency of the droplets sprinkled by the atomizer are varied by adjusting a gas to liquid ratio in the plurality of inlets.

26. A system comprising:
a plurality of fluid supply units;
at least one atomizer is configured to connect with the plurality of fluid supply units, wherein the atomizer comprises:
a body comprising a plurality of independent inlets connected to the plurality of fluid supply units, wherein the body has a central axis “X”;
a plurality of independent tubes coaxially integral with the body and connected to the plurality of inlets, wherein at least one tube is mounted along the central axis;
at least one nozzle having a rear end and a front end, mounted concentrically to the at least one tube mounted along the central axis;
at least one nozzle cap coupled concentrically to the body and the at least one nozzle mounted along the central axis enclosing the plurality of independent tubes and the at least one nozzle;
wherein the atomizer is configured to operate in at least one of a pneumatic mode and a hydraulic mode, when the atomizer receives at least one input fluid from at least one fluid supply unit from the plurality of supply units,
wherein the at least one nozzle is configured to receive at least one input fluid from at least one inlet from the plurality of inlets.

27. The system as claimed in claim 26, wherein the system further comprises a closure unit configured to seal at least one inlet of the atomizer.

28. The system as claimed in claim 26, wherein the system further comprises at least one auxiliary device coupled with at least one inlet from the plurality of inlets for preventing the leakage and reverse flow of the input fluid.
